(19) United States
(12) Patent Application Publication
(10) Pub. No.: US 2008/0284951 A1
(43) Pub. Date: Nov. 20, 2008

(54) LIQUID CRYSTAL DISPLAY DEVICE

(76) Inventors: Jong-Ho Son, Seoul (KR); Min-Goo Seok, Yongin-si (KR); Yong-Kuk Yun, Hwaseong-si (KR); Jang-Hyun Kim, Seoul (KR)

Correspondence Address: F. CHAU & ASSOCIATES, LLC, 130 WOODBURY ROAD, WOODBURY, NY, 11797, US

(21) Appl. No.: 12/099,197

(22) Filed: Apr. 8, 2008

(30) Foreign Application Priority Data
May 15, 2007 (KR) 2007-47028

(51) Int. Cl. G02F 1/1335

(52) U.S. Cl. 349/96

(57) ABSTRACT

A liquid crystal display (LCD) device includes a backlight assembly, a contrast ratio increasing LCD panel and an image displaying LCD panel. The contrast ratio increasing LCD panel is disposed on the backlight assembly to increase a contrast ratio. The image displaying LCD panel is disposed on the contrast ratio increasing LCD panel to display an image. Thus, the LCD device may have a high contrast ratio by increasing a contrast ratio between the luminance of a black color and the luminance of a white color.

### CROSS-REFERENCE TO RELATED APPLICATION

The present application claims priority under 35 U.S.C. §119 to Korean Patent Application No. 2007-47028, filed on May 15, 2007 in the Korean Intellectual Property Office (KIPO), the contents of which are herein incorporated by reference in their entirety.

### BACKGROUND OF THE INVENTION

1. Technical Field

The present invention relates to a liquid crystal display (LCD) device, and more particularly, to an LCD device capable of increasing a contrast ratio between the luminance of a black color and the luminance of a white color.

2. Discussion of the Related Art

A liquid crystal display (LCD) device includes an LCD panel displaying an image and a backlight assembly providing light to the LCD panel. Since the LCD device is thinner, lighter and consumes power less than conventional displays, the LCD device has been widely used for monitors, televisions, cellular phones, personal digital assistants (PDA), etc. The LCD device needs relatively high resolution and high contrast ratio to display a high quality image.

However, since the LCD panel displays an image by using a characteristic of which an externally applied voltage changes optical transmissivity, the capability of the LCD panel to substantially or completely block light is desired.

### SUMMARY OF THE INVENTION

Embodiments of the present invention provide a liquid crystal display (LCD) device having a high contrast ratio by increasing a contrast ratio between the luminance of a black color and the luminance of a white color.

In an exemplary embodiment of the present invention, an LCD device includes a backlight assembly, a contrast ratio increasing LCD panel and an image displaying LCD panel. The contrast ratio increasing LCD panel is disposed on the backlight assembly to increase a contrast ratio. The image displaying LCD panel is disposed on the contrast ratio increasing LCD panel to display an image. The LCD device may further include a lower polarizer disposed between the backlight assembly and the contrast ratio increasing LCD panel, an upper polarizer disposed on the image displaying LCD panel and a middle polarizer disposed between the image displaying LCD panel and the contrast ratio increasing LCD panel. The middle polarizer may have a transmission axis substantially perpendicular to the upper polarizer and the lower polarizer.

The contrast ratio increasing LCD panel may include a first substrate having pixels of three primary colors acting as one unit area. The contrast ratio increasing LCD panel may further include a second substrate facing the first substrate such that a liquid crystal layer is disposed between the first and second substrates, and including a transparent electrode and a black matrix. For example, the black matrix may be formed in an edge portion of the unit area.

The contrast ratio increasing LCD panel may change an incident initial linear polarization into a linear polarization, a phase difference of which is π rad. The contrast ratio increasing LCD panel may include a vertical alignment layer that has been rubbing-treated. The vertical alignment layer may be rubbed in an antiparallel direction.

The image displaying LCD panel may have color patterns of three primary colors formed in a zigzag shape. The image displaying LCD panel may have color patterns of three primary colors, each having a substantially rectangular shape that has a long side in a left and right viewing angles direction.

In an exemplary embodiment of the present invention, an LCD device includes a backlight assembly, a contrast ratio increasing LCD panel, an image displaying LCD panel, a lower polarizer, an upper polarizer and a middle polarizer. The contrast ratio increasing LCD panel is disposed on the backlight assembly to increase a contrast ratio. The image displaying LCD panel is disposed on the contrast ratio increasing LCD panel to display an image. The lower polarizer is disposed between the backlight assembly and the contrast ratio increasing LCD panel. The upper polarizer is disposed on the image displaying LCD panel and has substantially the same transmission axis as the lower polarizer. The middle polarizer is disposed between the image displaying LCD panel and the contrast ratio increasing LCD panel and has a transmission axis substantially perpendicular to the upper polarizer and the lower polarizer. The contrast ratio increasing LCD panel may include a first substrate including having pixels of three primary colors acting as one unit area, a second substrate including a transparent electrode and a black matrix formed in an edge portion of the unit area and a liquid crystal layer disposed between the first and second substrates. The contrast ratio increasing LCD panel may further include a vertical alignment layer that is rubbed in an antiparallel direction.

In an exemplary embodiment of the present invention, an LCD device includes a backlight assembly, a lower polarizer, a contrast ratio increasing LCD panel, a middle polarizer, an image displaying LCD panel and an upper polarizer. The lower polarizer is disposed on the backlight assembly. The contrast ratio increasing LCD panel is disposed on the lower polarizer to change an initial linear polarization passing through the lower polarizer into a linear polarization, a phase difference of which is π rad. The middle polarizer is disposed on the contrast ratio increasing LCD panel. The image displaying LCD panel is disposed on the middle polarizer to display an image, and has color patterns of three primary colors. The upper polarizer is disposed on the image displaying LCD panel. The color patterns of three primary colors may be formed in a zigzag shape. Each of the color patterns of three primary colors may have a substantially rectangular shape having a long side in a left and right viewing angles direction.

According to the above, an LCD device may have a high contrast ratio by increasing a contrast ratio between the luminance of a black color and the luminance of a white color.

### BRIEF DESCRIPTION OF THE DRAWINGS

Exemplary embodiments of the present invention can be understood in more detail from the following descriptions taken in conjunction with the accompanying drawings, in which:

FIG. 1 is an exploded perspective view illustrating a liquid crystal display (LCD) device according to an exemplary embodiment of the present invention;

FIGS. 2A to 2D are plan views illustrating first to fourth substrates of the LCD device illustrated in FIG. 1;

FIG. 3 is a plan view illustrating the first substrate illustrated in FIG. 1 according to an exemplary embodiment of the present invention;

FIG. 4 is a side view illustrating a color shift generated by using the first substrate illustrated in FIG. 2A;

FIG. 5 is a side view illustrating characteristics of left and right viewing angles of the first substrate illustrated in FIG. 3;

FIG. 6 is a plan view illustrating the first substrate illustrated in FIG. 1 according to an exemplary embodiment of the present invention;

FIG. 7 is a schematic view illustrating a Poincare sphere when a phase difference of a contrast ratio increasing LCD panel is not optimized; and

FIG. 8 is a schematic view illustrating a Poincare sphere when a phase difference of a contrast ratio increasing LCD panel is optimized.

### DESCRIPTION OF THE EMBODIMENTS

The invention is described more fully hereinafter with reference to the accompanying drawings, in which embodiments of the invention are shown. This invention may, however, be embodied in many different forms and should not be construed as limited to the embodiments set forth herein.

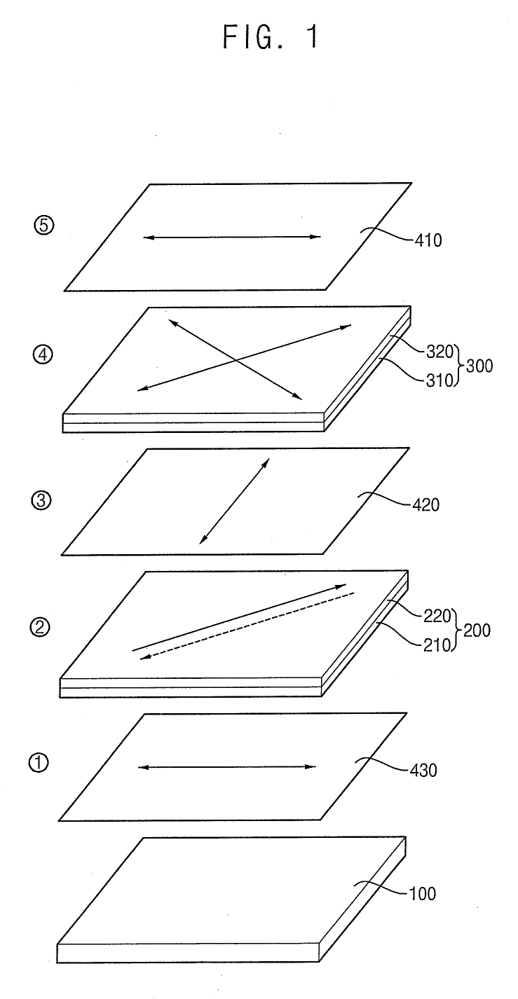

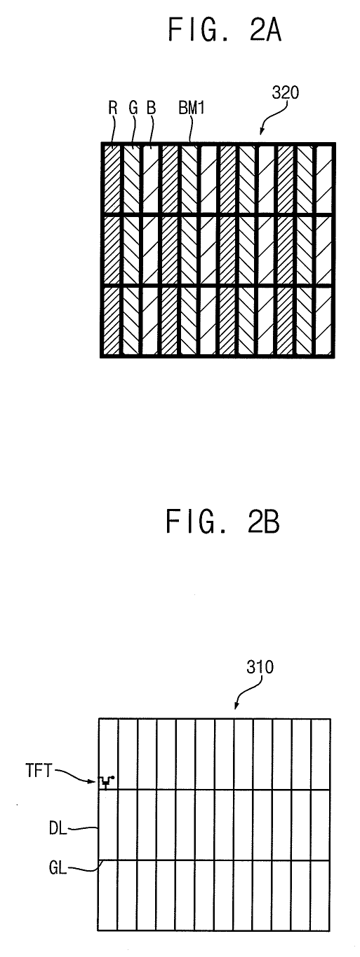

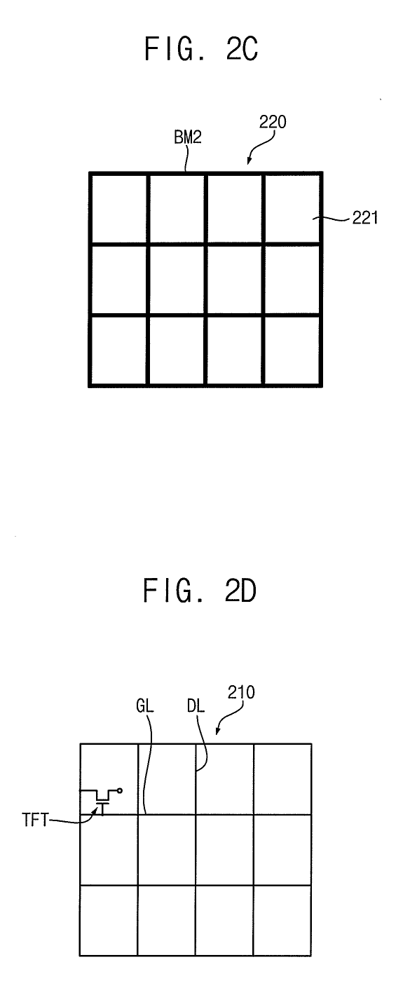

FIG. 1 is an exploded perspective view illustrating a liquid crystal display (LCD) device according to an exemplary embodiment of the present invention. FIGS. 2A to 2D are plan views illustrating first to fourth substrates of the LCD device illustrated in FIG. 1.

Referring to FIGS. 1 and 2A to 2B, an LCD device includes an image displaying LCD panel 300, a contrast ratio increasing LCD panel 200, a backlight assembly 100, an upper polarizer 410, a middle polarizer 420 and a lower polarizer 430.

The image displaying LCD panel 300 includes a first substrate 320, a second substrate 310 and a first liquid crystal layer (not shown). The first substrate 320 includes a plurality of pixels having, for example, three primary colors of red, green and blue colors. The second substrate 310 drives the pixels. The first liquid crystal layer is interposed between the first substrate 320 and the second substrate 310.

The first substrate 320 includes, for example, color patterns of red, green and blue R, G and B displaying colors, a common electrode (not shown) and a first black matrix BM1.

The second substrate 310 includes a plurality of gate lines GL, data lines DL, a plurality of pixel electrodes (not shown) arranged in a matrix and a plurality of thin-film transistors TFT connected to the pixel electrodes. The first liquid crystal layer may include liquid crystal molecules having optical anisotropy.

The contrast ratio increasing LCD panel 200 is disposed between the backlight assembly 100 and the image displaying LCD panel 300. The contrast ratio increasing LCD panel 200 may include a third substrate 220, a fourth substrate 210 and a second liquid crystal layer (not shown) interposed between the third substrate 220 and the fourth substrate 210.

In an exemplary embodiment, the third substrate 220 does not include red, green and blue color patterns to increase the luminance of a white color. The third substrate 220 includes a transparent electrode (not shown) and a second black matrix BM2. In order that pixels of three primary colors of red, green and blue may function as one unit area, the second black matrix BM2 may be formed only at an edge portion of the unit area. The third substrate 220 may include color patterns of red, green and blue R, G and B, which is similar to that of the first substrate 320.

The fourth substrate 210 includes gate lines GL and data lines DL arranged in a matrix, so that the pixels of three primary colors of red, green and blue may function as one unit area, a transparent pixel electrode (not shown) and a plurality of thin-film transistors TFT connected to the pixel electrode.

The backlight assembly 100 is disposed under the contrast ratio increasing LCD panel 200. The backlight assembly 100 may include a lamp unit (not shown), a light-guiding plate (not shown), a reflective sheet (not shown), optical sheets (not shown), a mold frame (not shown), and a lower receiving container (not shown).

In an exemplary embodiment, a light source of the lamp unit may include a line light source such as a cold cathode fluorescent lamp (CCFL), a hot cathode fluorescent lamp (HCFL), etc., and a point light source such as a light-emitting diode (LED), etc.

The light-guiding plate guides light emitted from the lamp unit to an upper side of the backlight assembly 100, for example, toward the contrast ratio increasing LCD panel 200. The light-guiding plate may include a material having high refractivity and transmittance.

The optical sheets may be disposed on the light-guiding plate. The optical sheets may uniformize the light guided by the light-guiding plate to be directed to the upper side of the backlight assembly 100. The optical sheets may include a transparent resin, for example, such as acrylic resin, polyurethane resin, silicon resin, etc.

The upper polarizer 410 is disposed on an outer side of the first substrate 320 of the image displaying LCD panel 300. The middle polarizer 420 is disposed between the image displaying LCD panel 300 and the contrast ratio increasing LCD panel 200. The lower polarizer 430 is disposed on an outer side of the fourth substrate 210 of the contrast ratio increasing LCD panel 200, or between the contrast ratio increasing LCD panel 200 and the backlight assembly 100.

The upper, middle and lower polarizers 410, 420 and 430 selectively transmit the light emitted from the backlight assembly 100. The upper, middle and lower polarizers 410, 420 and 430 transmit the light that only strongly vibrates in a predetermined direction. For example, the upper polarizer 410 and the lower polarizer 430 have substantially the same transmission axis, and the middle polarizer 420 has a transmission axis substantially perpendicular to the upper polarizer 410 and the lower polarizer 430.

The luminance of a black color may be lowered to obtain a high contrast ratio. In a vertical mode, in which a black color is obtained in an off state, for example, a vertical alignment (VA) mode, polarizers may be attached to upper and lower portions of an LCD panel to be substantially perpendicular to each other, to thereby prevent light from passing through a liquid crystal layer of the LCD panel. In another exemplary embodiment, in a horizontal mode such as an in-plane switching (IPS) mode, a fringe-field switching (FFS) mode, polarizers may be attached to upper and lower portions of an LCD panel to be substantially parallel with each other.

Since leakage of light exists after passing through the two substantially perpendicular polarizers, the capability to obtain a completely or substantially black color is needed. Thus, the middle polarizer 420 may be additionally disposed to be substantially perpendicular to the upper polarizer 410 and the lower polarizer 430 to lower the luminance of a black color.

For example, when the luminance of a black color is about 1,000 cd, and the luminance of the leaked light through substantially perpendicular polarizers is about 1 cd, the transmittance of a black color is about 1/1,000. In another exemplary embodiment, when light passing through the contrast ratio increasing LCD panel 200 further passes through the middle polarizer 420, the transmittance of a black color is about the square of 1/1,000, or about 1/1,000,000. Thus, the luminance of a white color is maintained while the transmittance of a black color is squared, thereby obtaining the square of a contrast ratio in comparison with using one image displaying LCD panel 300.

Since the second liquid crystal layer of the contrast ratio increasing LCD panel 200 may include liquid crystal molecules and a guest-host dye polymer contained therein, the dye polymer rotates with the liquid crystal molecules in an electric field direction according to the applying of a voltage to thereby increase the transmittance of light.

The third substrate 220 of the contrast ratio increasing LCD panel 200 may include transparent dummy glass that is not processed, and may be omitted to lighten and simplify the LCD device. In an exemplary embodiment of the present invention, the image displaying LCD panel 300 is firstly formed, and liquid crystal molecules are dropped onto the middle polarizer 420 by using the image displaying LCD panel 300 acting as a substrate.

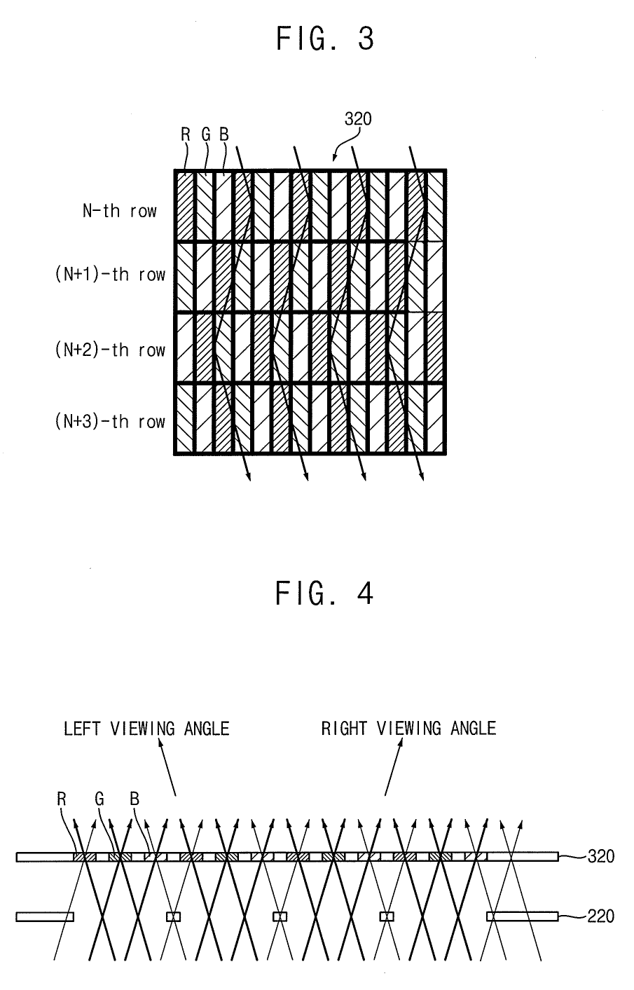

FIG. 3 is a plan view illustrating the first substrate illustrated in FIG. 1 according to an exemplary embodiment of the present invention.

Referring to FIGS. 1 and 3, the color patterns of red, green and blue R, G and B formed on the first substrate 320 of the image displaying LCD panel 300 may be alternately formed in a zigzag shape as illustrated in FIG. 3.

When light generated by the backlight assembly 100 passes through the second liquid crystal layer of the contrast ratio increasing LCD panel 200 and the first liquid crystal layer of the image displaying LCD panel 300, and arrives at the first substrate 320 having color patterns of red, green and blue R, G and B, the second black matrix BM2 formed on the third substrate 220 of the contrast ratio increasing LCD panel 200 or the data lines DL formed on the fourth substrate 210 of the contrast ratio increasing LCD panel 200 induces a shadow in a viewing angle direction to thereby cause reduction in color quality (hereinafter referred to as a color shift).

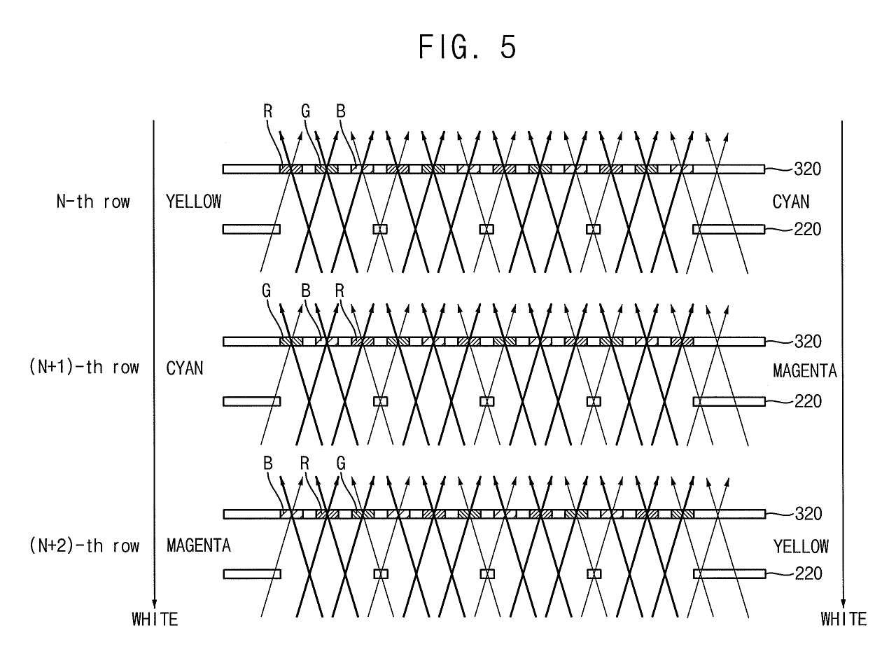

FIG. 4 is a side view illustrating a color shift generated by using the first substrate illustrated in FIG. 2A. FIG. 5 is a side view illustrating characteristics of left and right viewing angles of the first substrate illustrated in FIG. 3. Table 1 below shows colors measured at the left and right viewing angles in FIG. 4.

TABLE 1

| | Left Viewing Angle | | | Right Viewing Angle | | |
|---|---|---|---|---|---|---|
| | First | Third | Transmission | First | Third | Transmission |
| | Substrate | Substrate | Color | Substrate | Substrate | Color |
| Red | Red | White | Red | Red | BM | Dark Red |
| Green | Green | White | Green | Green | White | Green |
| Blue | Blue | BM | Dark Blue | Blue | White | Blue |

| | | |
|---|---|---|
| Total | Yellow Color | Cyan Color |

Referring to FIG. 4 and Table 1, when the color patterns of red, green and blue R, G and B are arranged in an order of red, green and blue, a blue color is shielded at a left viewing angle by the second black matrix BM2 of the third substrate 220 so that the color patterns are mixed to display a yellow color, and a red color is shielded at a right viewing angle by the second black matrix BM2 of the third substrate 220 so that the color patterns are mixed to display a cyan color.

According to an exemplary embodiment illustrated in FIGS. 3 and 5, as shown in FIG. 3, since the color patterns of red, green and blue R, G and B are repeatedly arranged in a predetermined pattern such that the color patterns are shifted in a left direction or a right direction by two columns while moving down two rows, and are shifted in the opposite direction by two columns while moving down the next two rows, the color patterns of red, green and blue R, G and B are uniformly shielded by the second black matrix BM2 of the third substrate 220, so that a color shift in which a displayed color varies according to viewing angle does not occur. Thus, a color shift of an N-th row may be mixed with a color shift of an (N+1)-th row and a color shift of an (N+2)-th row to counterbalance the color shifts, thereby preventing the above-described asymmetric color shift defect.

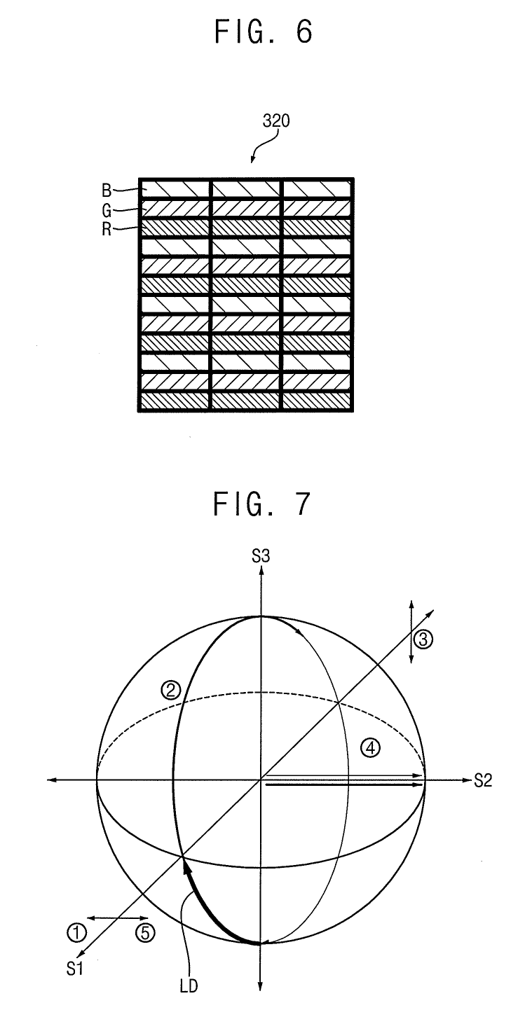

FIG. 6 is a plan view illustrating the first substrate illustrated in FIG. 1 according to an exemplary embodiment of the present invnetion.

Referring to FIG. 6, the color patterns of red, green and blue R, G and B, which have, for example, a rectangular shape, are rotated by about 90 degrees to be arranged so that a long side corresponds to a horizontal direction. Thus, reduction of color quality, which may be generated by mixing three primary colors as described in FIG. 4, may be alleviated at the left and right viewing angles.

Referring to FIGS. 1 and 2A to 2D, when the color patterns of red, green and blue R, G and B is formed on the third substrate 220 corresponding to an upper substrate of the contrast ratio increasing LCD panel 200, with two LCD panels being applied to the LCD device, and/or when a phase difference of the contrast ratio increasing LCD panel 200 is unoptimized, the luminance of a white color may be reduced. For example, when one color filter including the color patterns of red, green and blue R, G and B is applied to the LCD device, luminance is increased by about 40% (from about 100 cd to about 139 cd) in comparison with two color filters.

In an exemplary embodiment, the phase difference of the contrast ratio increasing LCD panel 200 may be generated by about π rad to optimize the phase difference of the contrast ratio increasing LCD panel 200. When the phase difference of the contrast ratio increasing LCD panel 200 is about π rad, all of the light that is generated from the backlight assembly 100 and passes through the lower polarizer 430 may be changed into a linear polarization substantially perpendicular to the initial linear polarization to entirely pass through the middle polarizer 420. An amount of the linear polarization of the light passing through the middle polarizer 420 is substantially the same as an amount of light passing through the lower polarizer of one conventional LCD panel, thereby obtaining substantially the same luminance as the conventional LCD panel.

To improve left and right visibility, polarization axes of the lower and middle polarizers 430 and 420 are twisted by about 45 degrees to have about 45 degrees and about 135 degrees, respectively, and the contrast ratio increasing LCD panel 200 may be antiparallelly rubbed in upper and lower directions. The image displaying LCD panel 300 may have a patterned vertical alignment (PVA) mode having a T-shape of about 0 degrees and about 90 degrees, not a PVA mode having a chevron shape of about 45 degrees and about 135 degrees.

Characteristics of a viewing angle of an LCD device may be analyzed by using a Poincare sphere.

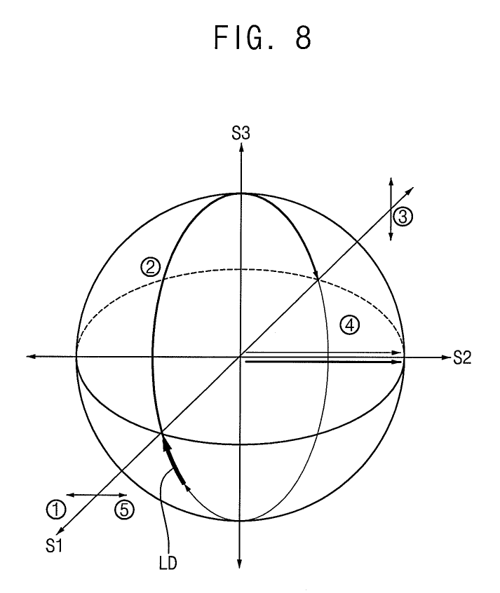

FIG. 7 is a schematic view illustrating a Poincare sphere when a phase difference of a contrast ratio increasing LCD panel is unoptimized. FIG. 8 is a schematic view illustrating a Poincare sphere when a phase difference of a contrast ratio increasing LCD panel is optimized. In FIGS. 7 and 8, the luminance becomes low as a difference LD between a vibration axis of light and a transmission axis of a polarizer increases.

Referring to FIGS. 1, 7 and 8, when the contrast ratio increasing LCD panel 200 has an unoptimized phase difference, the phase difference of the contrast ratio increasing LCD panel 200 is less than about π rad. Thus, the difference LD between a vibration axis of light and a transmission axis of a polarizer is great. In an exemplary embodiment, when the contrast ratio increasing LCD panel 200 has an optimized phase difference, the phase difference of the contrast ratio increasing LCD panel 200 is about π rad. Thus, difference LD between a vibration axis of light and a transmission axis of a polarizer becomes low. Therefore, as shown in FIG. 8, when the contrast ratio increasing LCD panel 200 has a phase difference of π rad, the luminance of a white color may be optimized.

In order that the phase difference of the contrast ratio increasing LCD panel 200 may be about π rad, an “antiparallel rubbing VA mode” may be applied to the contrast ratio increasing LCD panel 200 in which the phase difference may be about π rad in applying a voltage. Thus, the contrast ratio increasing LCD panel 200 may include a rubbing-treated vertical alignment layer.

In an exemplary embodiment, the anti-parallel rubbing VA mode is substantially the same as a conventional VA mode in that a vertical alignment layer is used to display a black color in an off state In the antiparallel rubbing VA mode, an antiparallel rubbing process is added to the conventional VA mode, so that the antiparallel rubbing VA mode has a pretilt angle of a predetermined direction in an initial state, and a liquid crystal director lies horizontally, coinciding with a rubbing direction in applying a voltage to display a white color. A mono transparent electrode is formed in a mono domain, and liquid crystal having negative dielectric anisotropy may be used.

When the phase difference of the contrast ratio increasing LCD panel 200 may be reversibly changed in all areas of effective pixels at the same time by about π rad, various liquid crystal modes such as a twisted nematic (TN) mode, an optically controlled birefringence (OCB) mode, an electrically controlled birefringence (ECB) mode, etc. may be applied to the present invention.

According to exemplary embodiments of the present invention, a contrast ratio increasing LCD panel is employed to increase an amount of light provided from a backlight assembly, thereby increasing a contrast ratio of an image displaying LCD panel. A color filter substrate of an image displaying LCD panel has pixels having three primary colors of red, green and blue, and the pixels are arranged in a zigzag shape or rotated by about 90 degrees, thereby reducing a screening effect at left and right viewing angles due to a black matrix of the contrast ratio increasing LCD panel. Thus, the uniformity of colors may be improved.

Although the exemplary embodiments of the present invention have been described herein with reference with the accompanying drawings, it is understood that the present invention is not be limited to these exemplary embodiments, and that various other changes and modifications can be affected therein by one of ordinary skill in the related art without departing from the scope or spirit of the invention. All such changes and modifications are intended to be included within the scope of the invention as defined by the appended claims.

What is claimed is:

1. A liquid crystal display (LCD) device comprising:
a backlight assembly;
a contrast ratio increasing LCD panel disposed on the backlight assembly; and
an image displaying LCD panel disposed on the contrast ratio increasing LCD panel.

2. The LCD device of claim 1, further comprising:
a lower polarizer disposed between the backlight assembly and the contrast ratio increasing LCD panel;
an upper polarizer disposed on the image displaying LCD panel; and
a middle polarizer disposed between the image displaying LCD panel and the contrast ratio increasing LCD panel.

3. The LCD device of claim 2, wherein the middle polarizer has a transmission axis substantially perpendicular to a transmission axis of the upper polarizer and the lower polarizer.

4. The LCD device of claim 1, wherein the contrast ratio increasing LCD panel comprises a first substrate having pixels of three primary colors acting as one unit area.

5. The LCD device of claim 4, wherein the contrast ratio increasing LCD panel further comprises a second substrate including a transparent electrode and a black matrix and a liquid crystal layer disposed between the first and second substrates.

6. The LCD device of claim 5, wherein the black matrix is formed at an edge portion of the unit area.

7. The LCD device of claim 1, wherein the contrast ratio increasing LCD panel changes an incident initial linear polarization into a linear polarization, and has a phase difference of π rad.

8. The LCD device of claim 7, wherein the contrast ratio increasing LCD panel comprises a vertical alignment layer formed by a rubbing treatment

9. The LCD device of claim 8, wherein the vertical alignment layer is rubbed in antiparallel directions.

10. The LCD device of claim 1, wherein the image displaying LCD panel has color patterns of three primary colors formed in a zigzag shape.

11. The LCD device of claim 1, wherein the image displaying LCD panel has color patterns of three primary colors, each having a substantially rectangular shape that has a long side in a left and right viewing angle direction.

12. An LCD device comprising:
a backlight assembly;
a contrast ratio increasing LCD panel disposed on the backlight assembly;
an image displaying LCD panel disposed on the contrast ratio increasing LCD panel;
a lower polarizer disposed between the backlight assembly and the contrast ratio increasing LCD panel;
an upper polarizer disposed on the image displaying LCD panel and having substantially the same transmission axis as the lower polarizer; and
a middle polarizer disposed between the image displaying LCD panel and the contrast ratio increasing LCD panel and having a transmission axis substantially perpendicular to the transmission axis of the upper polarizer and the lower polarizer.

13. The LCD device of claim 12, wherein the contrast ratio increasing LCD panel comprises:
a first substrate including pixels of three primary colors acting as one unit area;
a second substrate including a transparent electrode and a black matrix formed at an edge portion of the unit area; and
a liquid crystal layer disposed between the first and second substrates.

14. The LCD device of claim 13, wherein the contrast ratio increasing LCD panel further comprises a vertical alignment layer rubbed in antiparallel directions.

15. An LCD device comprising:
a backlight assembly;
a lower polarizer disposed on the backlight assembly;
a contrast ratio increasing LCD panel disposed on the lower polarizer to change an initial linear polarization passing through the lower polarizer into a linear polarization, wherein the contrast ratio increasing LCD panel has a phase difference of π rad;
a middle polarizer disposed on the contrast ratio increasing LCD panel;
an image displaying LCD panel disposed on the middle polarizer to display an image, and having color patterns of three primary colors; and
an upper polarizer disposed on the image displaying LCD panel.

16. The LCD device of claim 15, wherein the color patterns of the three primary colors are formed in a zigzag shape.

17. The LCD device of claim 15, wherein each of the color patterns of the three primary colors has a substantially rectangular shape having a long side in a left and right viewing angle direction.
